(19) United States
(12) Patent Application Publication
(10) Pub. No.: US 2023/0222764 A1
(43) Pub. Date: Jul. 13, 2023

(54) IMAGE PROCESSING METHOD, PATTERN INSPECTION METHOD, IMAGE PROCESSING SYSTEM, AND PATTERN INSPECTION SYSTEM

(71) Applicant: Hitachi High-Tech Corporation, Tokyo (JP)

(72) Inventors: Masanori OUCHI, Tokyo (JP); Masayoshi ISHIKAWA, Tokyo (JP); Yasutaka TOYODA, Tokyo (JP); Hiroyuki SHINDO, Tokyo (JP)

(73) Assignee: Hitachi High-Tech Corporation, Tokyo (JP)

(21) Appl. No.: 18/009,890

(22) PCT Filed: Jun. 16, 2020
(86) PCT No.: PCT/JP2020/023554

§ 371 Date: Dec. 12, 2022

(51) Int. Cl. G06V 10/75; G06T 7/00; G06V 10/74

(52) U.S. Cl. CPC G06V 10/751; G06T 7/0006; G06V 10/758; G06V 10/761; G06T 2207/30148

(57) ABSTRACT

An image processing method whereby data pertaining to an estimated captured image obtained from reference data of a sample is acquired using an input acceptance unit, an estimation unit, and an output unit. The data is used when comparing the estimated image and an actual image of the sample, wherein the method includes: an input acceptance unit accepting input of the reference data, process information pertaining to the sample, and trained model data; the estimation unit using the reference data, the process information, and the model data to calculate captured image statistics representing a probabilistic distribution of values attained by the data of the captured image; and the output unit outputting the captured image statistics, and generating the estimated captured image from the captured image statistics. This permits reducing the time required for estimation and to perform comparison in real time.

### TECHNICAL FIELD

The present invention relates to an image processing method, a pattern inspection method, an image processing system, and a pattern inspection system.

### BACKGROUND ART

Currently, for evaluation (defect inspection or the like) and dimension measurement using image data, design pattern data of an article that is an evaluation target or dimension measurement target is compared with a captured image. Examples of the article include a semiconductor circuit.

In inspection and measurement of a semiconductor circuit (hereinafter, also simply referred to as a “circuit”), processing of comparing design pattern data of the circuit with captured image data (hereinafter, also simply referred to as a “captured image”) and aligning them is performed. This processing is called pattern matching.

By aligning the design pattern data and the captured image, it is possible to designate a measurement point and evaluate the degree of deviation from a circuit pattern in the design pattern data. In the pattern, pattern deformation occurs due to various conditions set in a manufacturing process. In addition, in the captured image of the circuit, a difference in image quality (a contrast change, image noise generation, and the like) occurs due to various conditions set in an image capturing process. In addition, even under the same condition, the pattern of the circuit and the image quality of the captured image change due to the variation.

For example, in the pattern matching, in a case where the design pattern data is used as a template image as it is, the position alignment becomes difficult due to a difference between the circuit pattern in the design pattern data and the circuit pattern in the captured image. Therefore, it is preferable to use, as the template image, an image close to the circuit pattern in the captured image rather than directly using the design pattern data.

PTL 1 discloses a computer-implemented method for generating a simulation image from design pattern information, the computer-implemented method including: determining a feature of the design pattern information of a target object by inputting the design pattern information to two or more encoder layers of a generative model; and generating one or more simulation images by inputting the determined feature to two or more decoder layers of the generative model. Here, the simulation image indicates the design pattern information appearing in an image of the target object generated by an image system. PTL 1 also discloses that the generative model can be substituted by a convolutional neural network (CNN).

PTL 2 discloses a pattern inspection system that inspects an image of an inspection target pattern of an electronic device by using a discriminator configured by machine learning based on the image of the inspection target pattern and data used to manufacture the inspection target pattern, in which a plurality of pattern images of the electronic device and pattern data used to manufacture the pattern of the electronic device are stored, and a learning pattern image used for the machine learning is selected from the plurality of pattern images based on the stored pattern data and pattern images, thereby saving time and effort for creating a true value of learning data, reducing the amount of learning data, and shortening a training time.

### CITATION LIST

### Patent Literature

PTL 1: US 9,965,901
PTL 2: JP 2020-35282 A

### SUMMARY OF INVENTION

### Technical Problem

According to the method disclosed in PTL 1, when applied to an inspection target circuit pattern, a circuit pattern as the simulation image is obtained, but since only the design pattern data is input, a difference in condition of a manufacturing process, an image capturing process, or the like (hereinafter, also referred to as “process information”) cannot be explicitly specified. In order to make a difference in this condition, it is necessary to prepare a dataset including a captured image of a circuit manufactured or imaged under the condition and train a mathematical model for simulation for each condition.

Hitherto, it is necessary to operate a simulator a plurality of times for each condition in order to know an influence of the process information on the circuit and the captured image thereof. Since the conventional simulator uses a Monte Carlo method or the like, the simulation takes time. In addition, process simulation for a commercially available semiconductor circuit is divided for each process such as lithography, etching, or an image capturing process. In order to combine these processes and comprehensively grasp a relationship of parameters between the processes, it is necessary to use the simulator in multiple stages.

However, since a method requiring a long time for calculation such as Monte Carlo simulation is adopted for simulation of a manufacturing process or image capturing process, it takes a huge amount of time for one trial. Such calculation requires a plurality of trials in order to cope with a plurality of conditions and parameters, and even in a case where a plurality of simulators are used, it takes a lot of calculation time and calculation cost, which is not realistic.

The pattern inspection system disclosed in PTL 2 makes it possible to reduce the amount of learning data and shorten the training time at the time of machine learning, and it is considered that it is necessary to separately improve a data processing method in a case where the obtained learning data is used at the time of actual inspection.

An object of the present invention is to reduce a time required for estimation and to perform comparison in real time when comparing a simulation image estimated from design pattern data and an image that has actually been captured.

### Solution to Problem

An image processing method for acquiring data of an estimated captured image obtained from reference data of a sample by using a system including an input acceptance unit, an estimation unit, and an output unit, the data being used when comparing the estimated captured image and an actual captured image of the sample, the image processing method including: an input step of accepting, by the input acceptance unit, input of the reference data, process information of the sample, and trained model data; an estimation step of calculating, by the estimation unit, captured image statistics which represent a probabilistic distribution of values that are attainable by the data of the captured image by using the reference data, the process information, and the model data; and an output step of outputting, by the output unit, the captured image statistics, in which the estimated captured image is able to be generated from the captured image statistics.

### Advantageous Effects of Invention

According to the present invention, it is possible to reduce a time required for estimation and to perform comparison in real time when comparing a simulation image estimated from design pattern data and an image that has actually been captured.

### BRIEF DESCRIPTION OF DRAWINGS

FIG. 1A is a diagram illustrating an example of a captured image obtained from design pattern data and process information.

FIG. 1B is a diagram illustrating another example of the captured image obtained from the design pattern data and the process information.

FIG. 2 is a configuration diagram illustrating an image processing system according to an embodiment.

FIG. 3A is a configuration diagram illustrating a flow of data processed in the image processing system according to the embodiment.

FIG. 3B is a configuration diagram illustrating a flow of data processed in the image processing system according to the embodiment.

FIG. 4 is a flowchart illustrating an example of learning processing according to the embodiment.

FIG. 5 is a configuration diagram illustrating a pattern inspection system.

FIG. 6A is a schematic diagram illustrating an example of converting a design pattern data image into a feature.

FIG. 6B is a schematic diagram illustrating an example of a combination form of the feature and the process information.

FIG. 7A is a schematic diagram illustrating an example of an input form according to the embodiment.

FIG. 7B is a schematic diagram illustrating an example of the combination form according to the embodiment.

FIG. 8A is a diagram illustrating an example of the design pattern data image.

FIG. 8B is a diagram illustrating an example of a captured image corresponding to a design pattern data image 801 in FIG. 8A.

FIG. 8C is a diagram illustrating an example of a captured image corresponding to the design pattern data image 801 in FIG. 8A.

FIG. 8D is a diagram illustrating an example of a captured image corresponding to the design pattern data image 801 in FIG. 8A.

FIG. 9 is a graph illustrating an example of an expression format of captured image statistics.

FIG. 10A is a diagram illustrating an example of the design pattern data image.

FIG. 10B is a diagram illustrating an example of the captured image.

FIG. 11 is a configuration diagram illustrating a graphical user interface (GUI) for estimating the captured image statistics and evaluating a circuit.

FIG. 12 is a configuration diagram illustrating a GUI for performing learning processing.

FIG. 13 is a schematic configuration diagram illustrating an example of a semiconductor metrology system.

FIG. 14 is a schematic configuration diagram illustrating a scanning electron microscope.

### DESCRIPTION OF EMBODIMENTS

The present invention relates to image processing technologies for processing image data. Among the technologies, the present invention particularly relates to an image processing technology applicable to inspection using image data. Examples of an inspection target include a semiconductor circuit.

Hereinafter, an image processing method, a pattern inspection method, an image processing system, and a pattern inspection system according to an embodiment of the present invention will be described.

In an image processing method and an image processing system, captured image statistics are calculated from design pattern data and process information, the captured image statistics representing a probabilistic distribution of values that are attainable by each pixel of a captured image as a variation of the captured image corresponding to the design pattern data and the process information.

The image processing system includes a CNN model capable of calculating the probabilistic distribution in units of pixels representing the variation of the captured image from the design pattern data and the process information. Here, the CNN is an abbreviation for convolutional neural network.

The image processing system evaluates an influence of the process information on a circuit or a captured image thereof by using the calculated probabilistic distribution in units of pixels. In addition, a pattern inspection system creates a template image that can be used for pattern matching by using the calculated probabilistic distribution in units of pixels, and performs the pattern matching with high accuracy. Furthermore, the present embodiment includes determining a parameter (model data) included in a mathematical model using the CNN in machine learning or the like.

Examples of the inspection target can include various articles such as an automobile part (a piston or the like), a tray, a container such as a bin, and a liquid crystal panel, in addition to the semiconductor circuit. Examples of the pattern include a size, a length, and the like of a sample (article).

The image processing method described below relates to an image processing method for directly estimating a variation of a captured image of a circuit manufactured under conditions of design pattern data that is reference data of the circuit and process information by using the design pattern data, the process information, and trained model data, and an image inspection system using the image processing method.

Furthermore, an example of a method of learning a correspondence relationship among a design pattern data image obtained by imaging design pattern data, process information, and a captured image of a circuit by using machine learning, and directly estimating, from an arbitrary design pattern data image and arbitrary process information, a variation of the captured image of the circuit corresponding to the arbitrary design pattern data image and the arbitrary process information by using model data obtained by the learning is described as a specific example thereof. In the following, the variation of the captured image of the circuit is treated as statistics (a mean, a variance, or the like) that define a probabilistic distribution of pixel values that can be attained by each pixel of the image. As a result, deformation of the circuit and a change in image quality of the captured image can be grasped as the pixel value and the variation thereof.

Hereinafter, a device or a measurement inspection system having a function of accepting input of design pattern data, process information, and trained model data of an arbitrary circuit, directly estimating a variation of a captured image of the circuit corresponding to a combination of the design pattern data and the process information as statistics of pixel values, and outputting the estimated statistics will be described with reference to the drawings. More specifically, a device including a critical dimension-scanning electron microscope (CD-SEM), which is a type of measurement device, and a system thereof will be described.

In the following description, a charged particle beam device is exemplified as a device that forms a captured image of a circuit. In the present specification, an example in which a scanning electron microscope (SEM), which is a type of charged particle beam device, is used is described, but the present invention is not limited thereto, and for example, a focused ion beam (FIB) device that scans an ion beam on a sample to form an image may be adopted as the charged particle beam device. However, in order to measure a fine pattern with high accuracy, an extremely high magnification is required. Therefore, in general, it is desirable to use the SEM superior to the FIB device in terms of resolution. Embodiment

FIG. 13 is a schematic configuration diagram illustrating an example of a semiconductor metrology system, and illustrates a measurement/inspection system in which a plurality of measurement devices or inspection devices are connected to a network. Here, the measurement/inspection system is included in the image processing system or the pattern inspection system.

The system illustrated in FIG. 13 includes a critical dimension-scanning electron microscope (CD-SEM) 1301 that measures a pattern dimension of a semiconductor wafer, a photomask, or the like, a defect inspection device 1302 that acquires an image by irradiating a sample with an electron beam and extracts a defect based on comparison between the image and a reference image registered in advance, a condition setting device 1303, a simulator 1304, and a storage medium 1305 (storage unit). These are connected via a network.

The condition setting device 1303 has a function of setting a measurement position, a measurement condition, and the like on design pattern data of a semiconductor device. The simulator 1304 has a function of simulating a manufacturing quality of a pattern based on the design pattern data of the semiconductor device, a manufacturing condition of a semiconductor manufacturing device, and the like. Furthermore, the storage medium 1305 stores the design pattern data in which layout data of the semiconductor device and the manufacturing condition are registered, and the like. The storage medium 1305 may store trained model data.

The design pattern data is expressed in, for example, a GDS format or an OASIS (registered trademark) format, and is stored in a predetermined format. The type of the design pattern data is not limited as long as software that displays the design pattern data can display its format and can handle the design pattern data as graphic data.

Furthermore, the storage medium 1305 may be embedded in a control device of the measurement device or inspection device, the condition setting device 1303, or the simulator 1304. The CD-SEM 1301 and the defect inspection device 1302 include control devices, respectively, and control necessary for each device is performed. However, a function of the simulator and the function of setting the measurement condition or the like may be incorporated in these control devices.

In the SEM, an electron beam emitted from an electron source is focused by a plurality of layers of lenses, and the focused electron beam is used to scan one-dimensionally or two-dimensionally on the sample by a scanning deflector.

A secondary electron (SE) or backscattered electron (BSE) emitted from the sample by the scanning of the electron beam is detected by a detector and stored in a storage medium such as a frame memory in synchronization with the scanning by the scanning deflector. An image signal stored in the frame memory is integrated by an arithmetic device embedded in the control device. The scanning by the scanning deflector can be performed in any size, position, and direction.

The control and the like as described above are performed by the control device of each SEM, and an image or signal obtained as a result of the scanning of the electron beam is transmitted to the condition setting device 1303 via a communication line network.

In this example, the control device that controls the SEM and the condition setting device 1303 are described as separate devices, but the present invention is not limited thereto. For example, the device control and measurement processing may be collectively performed by the condition setting device 1303, or the SEM control and measurement processing may be performed together by each control device.

In addition, a program for performing the measurement processing is stored in the condition setting device 1303 or the control device, and measurement or arithmetic operation is performed according to the program.

In addition, the condition setting device 1303 has a function of creating a program (recipe) for controlling operation of the SEM based on the design pattern data of the semiconductor, and functions as a recipe setting unit. Specifically, on the design pattern data, contour line data of the pattern, or the design pattern data subjected to the simulation, a position for performing processing necessary for the SEM such as a desired measurement point, autofocusing, automatic astigmatism correction, or an addressing point is set. Then, a program for automatically controlling a sample stage of the SEM, the deflector, and the like is created based on the setting. In addition, in order to create a template to be described later, a processor that extracts information of an area to be a template from the design pattern data and creates the template based on the extraction information, or a program that causes a general-purpose processor to create the template is embedded or stored. In addition, this program may be distributed via a network.

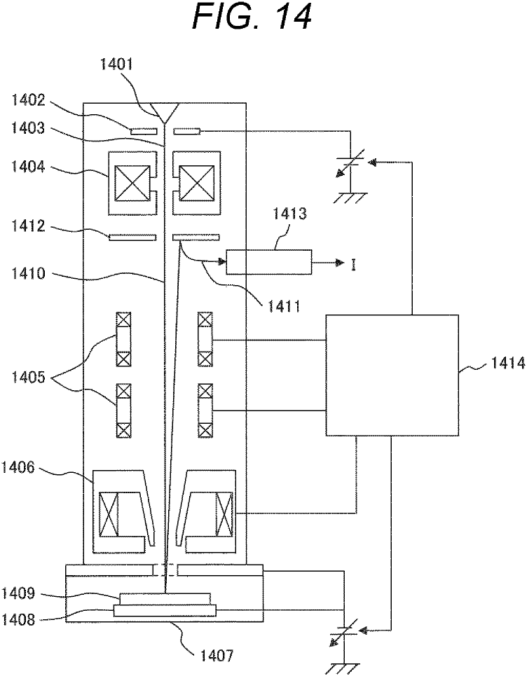

FIG. 14 is a schematic configuration diagram illustrating the scanning electron microscope.

The scanning electron microscope illustrated in FIG. 14 includes an electron source 1401, an extraction electrode 1402, a condenser lens 1404 which is a type of focusing lens, a scanning deflector 1405, an objective lens 1406, a sample stage 1408, a conversion electrode 1412, a detector 1413, a control device 1414, and the like.

An electron beam 1403 extracted from the electron source 1401 by the extraction electrode 1402 and accelerated by an acceleration electrode (not illustrated) is narrowed by the condenser lens 1404. Then, the scanning deflector 1405 performs scanning on a sample 1409 one-dimensionally or two-dimensionally. The electron beam 1403 is decelerated by a negative voltage applied to an electrode provided on the sample stage 1408, and is focused by a lens action of the objective lens 1406 to irradiate the sample 1409 with the electron beam 1403.

When the sample 1409 is irradiated with the electron beam 1403, electrons 1410 such as the secondary electron and the backscattered electron are emitted from the irradiated portion. The emitted electrons 1410 are accelerated toward the electron source by an acceleration action based on the negative voltage applied to the sample, collide with the conversion electrode 1412, and generate a secondary electron 1411. The secondary electron 1411 emitted from the conversion electrode 1412 is captured by the detector 1413, and an output I of the detector 1413 changes depending on the amount of captured secondary electrons. A luminance of a display device (not illustrated) changes depending on the output I. For example, in a case of forming a two-dimensional image, an image of a scanning area is formed by synchronizing a deflection signal to the scanning deflector 1405 with the output I of the detector 1413. In addition, the scanning electron microscope illustrated in FIG. 14 includes a deflector (not illustrated) that moves in the scanning area of the electron beam.

In the example in FIG. 14, an example in which the electron emitted from the sample is converted by the conversion electrode and then detected has been described. However, it is a matter of course that the present invention is not limited to such a configuration, and for example, a configuration in which a detection surface of an electron multiplier tube or the detector is arranged on an orbit of the accelerated electron can be adopted.

The control device 1414 controls each component of the scanning electron microscope, and has a function of forming an image based on a detected electron and a function of measuring a pattern width of a pattern formed on the sample based on an intensity distribution of the detected electron called a line profile.

Next, an example of processing of estimating a variation of a captured image of a circuit as statistics of pixel values by using machine learning, processing of learning a parameter (model data) of a model capable of estimating the statistics, or process information evaluation processing or pattern matching processing using the statistics will be described.

The statistics estimation processing or the model data learning processing can also be performed by an arithmetic device embedded in the control device 1414 or an arithmetic device having an image processing function. Furthermore, the processing can be performed by an external arithmetic device (for example, the condition setting device 1303) via a network. Note that processing sharing between the arithmetic device embedded in the control device 1414 or the arithmetic device having the image processing function and the external arithmetic device can be appropriately set, and is not limited to the above-described example.

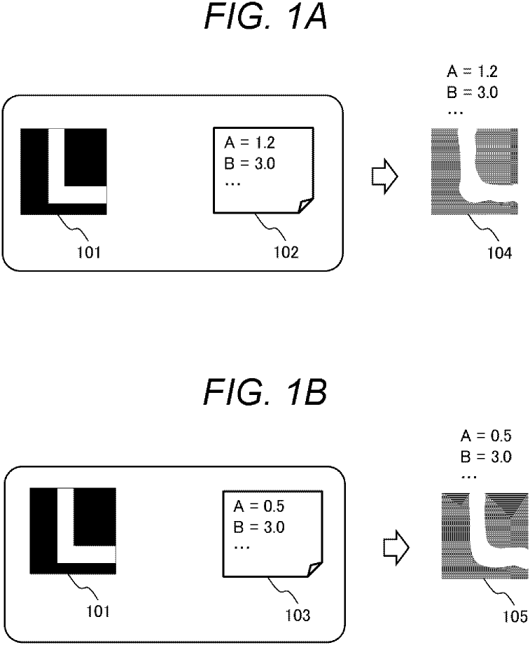

FIG. 1A is a diagram illustrating an example of a captured image obtained from the design pattern data and the process information.

In FIG. 1A, a captured image 104 of the circuit is obtained from design pattern data image 101 and predetermined process information 102.

The design pattern data image 101 is a form of reference data representing wiring of the circuit and an arrangement thereof.

FIG. 1B is a diagram illustrating another example of the captured image obtained from the design pattern data and the process information.

In FIG. 1B, a captured image 105 of the circuit is obtained from the design pattern data image 101 and predetermined process information 103.

These diagrams illustrate that the captured image is different in a case where the process information is different even when using the same design pattern data image 101.

In the present embodiment, a design pattern data image obtained by imaging the design pattern data described in CAD data or the like is used. Examples thereof include a binary image in which a wiring portion and the other area of the circuit are painted differently. In a case of the semiconductor circuit, there is also a multilayer circuit having two or more layers of wiring. For example, in a case where the number of layers of wiring is one, a binary image with a wiring portion and the other area can be used, and in a case where the number of layers of wiring is two, a ternary image with lower and upper wiring portions and the other area can be used. The design pattern data image is an example of the reference data, and is not limited thereto.

The pieces of process information 102 and 103 are one or more types of parameters used in each process from manufacturing to image capturing of the circuit. In the present embodiment, the process information is treated as a real number. Specific examples of the process include an etching process, a lithography process, and an image capturing process by the SEM. Specific examples of the parameter include an exposure dose and a focus in the lithography process.

The captured images 104 and 105 of the circuit are captured images of the circuit manufactured using the pieces of process information 102 and 103, respectively, based on the design pattern data indicated by the design pattern data image 101. The captured image handled in the present embodiment is treated as a grayscale image captured by the SEM. Therefore, the captured image itself has an arbitrary height and width, and a channel of the image is 1.

The circuit is deformed to an acceptable degree without any electrical problem due to the parameter of the manufacturing process, and does not have a circuit pattern as in the design pattern data. In addition, in the captured image of the circuit, the appearance of the circuit varies depending on the parameter of the image capturing process using the SEM. Therefore, although the captured image 104 and the captured image 105 correspond to the same design pattern data image 101, the process information is different. Accordingly, the deformation amount of the circuit is not the same, and the image quality of the image is also different. Here, specific examples of the image quality of the image include a noise and a contrast change.

Even in a case where the design pattern data and the process information are the same, obtained captured images of the circuit are not exactly the same. This is because even if the parameter of the manufacturing process or the image capturing process is set, process fluctuation occurs, and thus, variations occur in the obtained results.

In the present embodiment, the reference data is the design pattern data image, the process information is a real number indicating the parameter value, and the captured image of the circuit is captured by the SEM. However, the present invention is not limited thereto.

Next, processing of estimating a variation of the captured image as the statistics of the pixel values will be described.

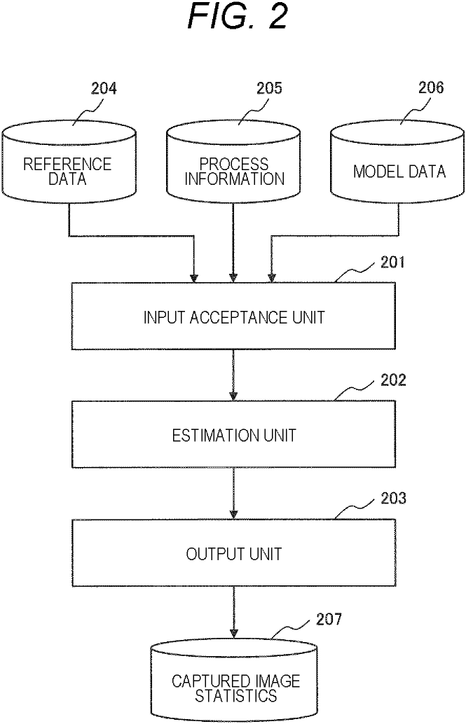

FIG. 2 is a configuration diagram illustrating the image processing system according to the present embodiment.

As illustrated in FIG. 2, the image processing system includes an input acceptance unit 201, an estimation unit 202, and an output unit 203. Furthermore, the image processing system includes a storage unit as appropriate.

The input acceptance unit 201 accepts input of reference data 204, process information 205, and trained model data 206. Then, the estimation unit 202 converts the input accepted by the input acceptance unit 201 into statistics representing a variation of the captured image of the circuit. The output unit 203 outputs the statistics as captured image statistics 207.

The reference data 204 describes the pattern of the wiring of the circuit and arrangement thereof, and is treated as the design pattern data or the design pattern data obtained by imaging in the present embodiment.

The estimation unit 202 converts the input accepted by the input acceptance unit 201 into statistics representing a variation of the captured image of the corresponding circuit. In order to perform this conversion, the estimation unit 202 includes a mathematical model in which a parameter is set based on the model data 206 and the captured image statistics are estimated from the design pattern data image and the process information.

Specifically, a convolutional neural network (CNN) is used. In the CNN, an encoder includes two or more convolutional layers and a pooling layer, and a decoder includes two or more deconvolutional layers. In this case, the model data is a weight (conversion parameter) of a filter of each layer included in the CNN. A mathematical model other than the CNN model can be used as the mathematical model for estimating the captured image statistics, and the mathematical model is not limited thereto.

The input acceptance unit 201 reads the reference data 204, the process information 205, and the model data 206 according to a predetermined format.

The output unit 203 outputs an arithmetic operation result in the estimation unit 202 in a predetermined format.

The input acceptance unit 201, the estimation unit 202, and the output unit 203 illustrated in FIG. 2 are a part of the components of the system illustrated in the present embodiment, and may be dispersedly arranged in a plurality of computers connected by a network. In addition, data including the input reference data 204, process information 205, and the trained model data 206, and the like may be input from the outside by a user, or may be stored in a predetermined storage device.

A correspondence relationship between the design pattern data image and the captured image will be described.

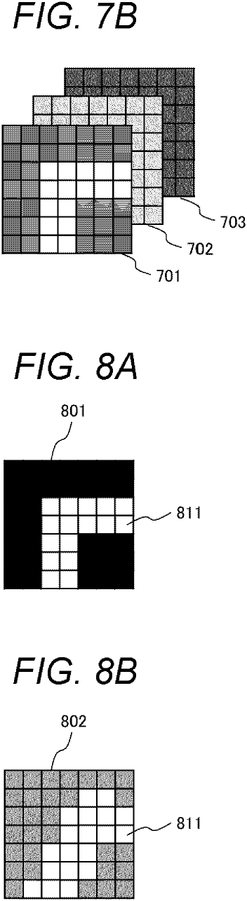

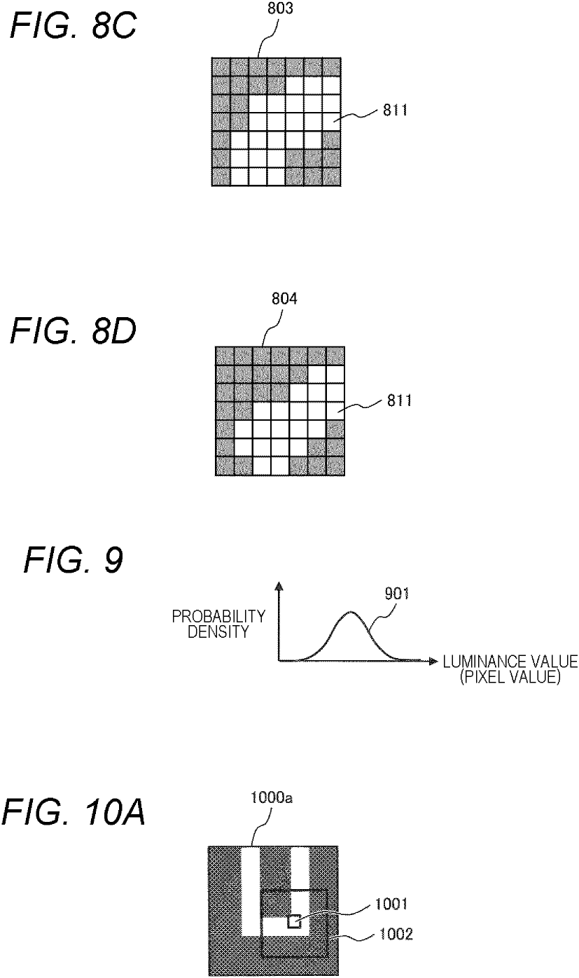

Specifically, an example of a pattern deviation of the wiring between the design pattern data image and an inspection target image will be described with reference to FIGS. 8A to 8D.

FIG. 8A is a diagram illustrating an example of the design pattern data image.

In FIG. 8A, a design pattern data image 801 includes wiring 811 including white pixels (squares). Since the design pattern data image 801 is based on the design pattern data, the ideally orthogonal wiring 811 is shown.

FIGS. 8B to 8D are diagrams illustrating examples of the captured image corresponding to the design pattern data image 801 of FIG. 8A.

FIG. 8B illustrates a captured image 802 corresponding to the design pattern data image 801.

FIG. 8C illustrates a captured image 803 corresponding to the design pattern data image 801.

FIG. 8D illustrates a captured image 804 corresponding to the design pattern data image 801.

The captured image 802 in FIG. 8B, the captured image 803 in FIG. 8C, and the captured image 804 in FIG. 8D are affected by at least one of a manufacturing condition or an image capturing condition. Therefore, the pattern of the wiring 811 is different in each of the captured images 802, 803, and 804. In other words, the difference in pattern of the wiring 811 occurs depending on the number of times the manufacturing is performed and depending on the number of times the image capturing is performed. Therefore, when a certain pixel on the design pattern data image attains an arbitrary luminance value, there are a plurality of luminance values that can be attained by the same pixel on the captured image.

For example, in a case where the captured images 802, 803, and 804 are grayscale images, a luminance value that can be attained by each pixel is an integer from 0 to 255. In this case, a luminance value distribution represents a frequency with respect to the luminance value of 0 to 255. Examples of the statistics include a mean and a standard deviation in a case where the luminance value distribution is a Gaussian distribution, and an arrival rate in a case where the luminance value distribution is a Poisson distribution.

In summary, a probability density distribution of the pixel values such as the luminance values can be defined for the design pattern data under a certain manufacturing condition or image capturing condition.

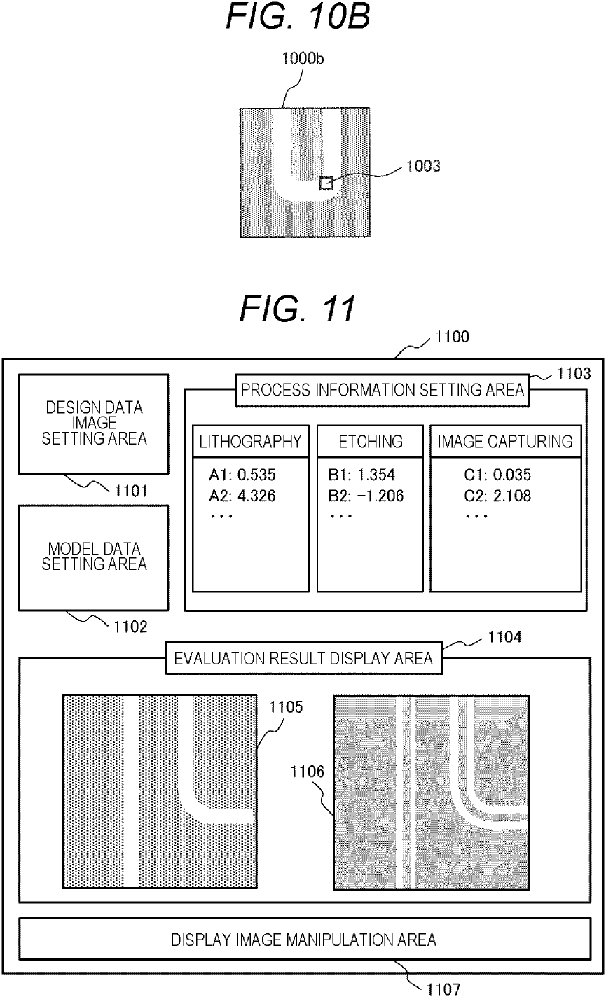

FIG. 10A is a diagram illustrating an example of the design pattern data image.

In FIG. 10A, a pixel 1001 of interest and a surrounding area 1002 thereof are shown in a design pattern data image 1000a.

FIG. 10B is a diagram illustrating an example of the captured image.

In FIG. 10B, a pixel 1003 is shown in a captured image 1000b.

The pixel 1001 of interest in FIG. 10A and the pixel 1003 in FIG. 10B are positioned at the same coordinates when aligned for comparison with the image of the circuit (sample). Statistics of pixel values that can be attained by the pixel 1003 are estimated from pixel values of the pixel 1001 of interest and the surrounding area 1002. This is because an arithmetic operation including the surrounding pixels is performed when calculation is performed in the convolutional layer of the CNN. The size of the surrounding area 1002 is determined by a filter size, a stride size, and the like of the CNN.

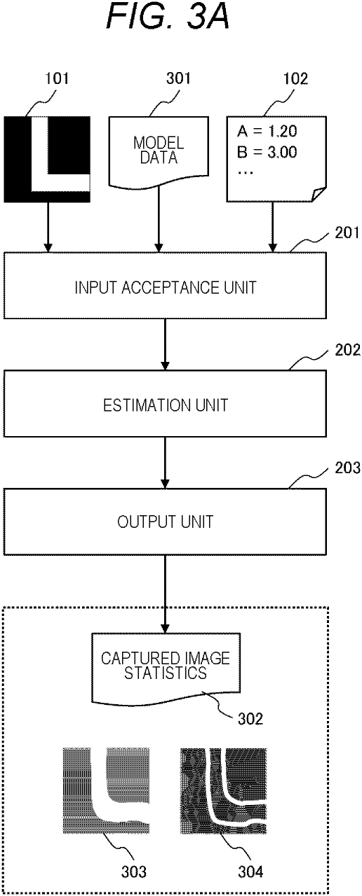

FIGS. 3A and 3B are configuration diagrams illustrating a flow of data processed in the image processing system according to the present embodiment.

In FIGS. 3A and 3B, the input acceptance unit 201 accepts input of the design pattern data image 101, the process information 102 or 103, and the model data 301, the estimation unit 202 converts the input into statistics that define a variation of the captured image of the corresponding circuit, and the output unit 203 outputs the calculated captured image statistics 302 or 305.

Comparing FIG. 3A with FIG. 3B, even in a case where the design pattern data image 101 and the model data 301 are common, when the process information 102 of FIG. 3A is changed to the process information 103 of FIG. 3B, the output becomes the captured image statistics 305 of FIG. 3B different from the captured image statistics 302 of FIG. 3A. A mean image 306 and a standard deviation 307 as output formats are different from a mean image 303 and a standard deviation image 304. As a result, information regarding a mean change in circuit image due to a difference in process information, a difference in image quality, a position of a portion having a large variation, the degree of variation, and the like can be obtained.

FIG. 9 is a graph illustrating an example of an expression format of the captured image statistics.

In FIG. 9, the captured image statistics are represented as a probability density function 901 that is a probabilistic distribution of pixel values of each pixel. For example, in a case where the captured image statistics 302 in FIG. 3A are represented by the probability density function 901, values of a mean and a standard deviation of the probability density function 901 are obtained. Similarly, when the values of the mean and the standard deviation for each pixel are obtained, the mean image 303 and the standard deviation image 304 are obtained.

The probability density function 901 is represented by a probability density function of an appearance frequency with respect to a pixel value that can be attained by each pixel on a captured image of a certain circuit. Specifically, in a case where the captured image is a grayscale image, the distribution can be defined as the appearance frequencies of 256 pixel values. Note that the statistics may be in units other than pixels.

For example, assuming that the probability density function 901 is a Gaussian distribution, the probability density function 901 can be uniquely defined by its mean and standard deviation (or variance).

The mean image 303 and the standard deviation image 304 are examples of an output format of the captured image statistics 302. In a case where the captured image statistics are a Gaussian distribution for each pixel, the captured image statistics can be estimated and output as a mean image and a standard deviation image obtained by converting values of a mean and a standard deviation thereof into images.

The mean image 303 is obtained by converting a mean of the Gaussian distribution of each pixel into a grayscale image. Assuming that the captured image statistics 302 are a Gaussian distribution, a mean value of the distribution coincides with the mode value, and thus, the obtained mean image 303 is a captured image using the design pattern data image 101 and having the most mean circuit pattern under the condition of the process information 102.

The standard deviation image 304 is obtained by converting a standard deviation of a Gaussian distribution of each pixel into a grayscale image. By performing imaging while maintaining a relative relationship of a standard deviation between pixels, it is possible to visualize an image area in which circuit deformation or image quality change of the image is large. For example, in the semiconductor circuit, since the deformation frequently occurs at an edge of the wiring (line), the variation (standard deviation) increases. On the other hand, since the deformation is rare in an area other than the edge of the wiring and a space portion other than the wiring, the variation is reduced. The standard deviation in the present embodiment serves to absorb process fluctuation when manufacturing and image capturing are performed under the conditions of certain design pattern data and process information.

As described above, the pattern of the manufactured circuit and the image quality of the captured image depend on the process information.

By performing the processing as illustrated in FIGS. 3A and 3B, in a case where there are design pattern data and trained model data, it is possible to know an influence on the circuit and the captured image of the circuit when the input process information is changed without actually manufacturing the circuit and capturing the captured image.

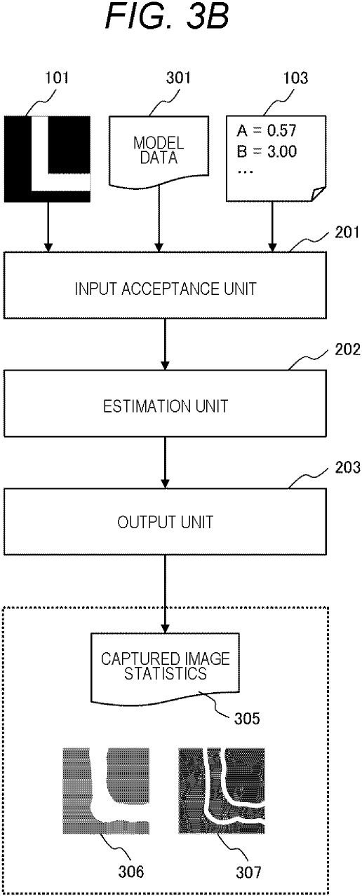

FIG. 4 is a flowchart illustrating an example of learning processing for creating model data used for estimation of captured image statistics.

The learning processing is performed by a machine learning unit.

In the learning processing illustrated in FIG. 4, the user inputs model data (S401), and the user inputs a design pattern data image and process information (S402). Then, the machine learning unit estimates and outputs captured image statistics from the inputs (S403). Here, the inputs by the user do not have to be performed by the user, and may be performed, for example, by automatically selecting data included in a predetermined storage unit and reading the data by the machine learning unit.

Then, it is determined whether or not a learning termination condition is satisfied (learning necessity determination step S404) .

In a case where the termination condition is not satisfied, a captured image as training data is input (S405). Then, the captured image (training data) is compared with the estimated image information (captured image statistics) (S406), and the model data is updated according to the comparison result (S407). Examples of the comparison method include a method of converting the estimated image information (captured image statistics) into an “estimated captured image” and performing comparison. In other words, the estimated captured image can be generated from the captured image statistics.

On the other hand, in a case where the termination condition is satisfied in S404, the model data is stored (S408), and the learning processing is terminated.

In a case where the trained model data is stored in advance in the storage medium 1305 (FIG. 13), the input of S401 can be omitted.

S401 and S402 are also collectively referred to as an “input step”. Further, S403 is also referred to as an “estimation step”. Furthermore, from the viewpoint of performing the processing corresponding to the output unit 203 in FIG. 2, S403 can also be referred to as an “output step”.

The processing content will be described in detail below.

The model data input in S401, updated in S407, and stored in S408 is the weight of the filter of the convolutional layer or the deconvolutional layer used in S403. In other words, the model data is configuration information of each layer of the encoder and the decoder of the CNN used in S403 and the conversion parameter (weight) thereof. This conversion parameter is determined in such a way as to minimize a value of a loss function calculated using the captured image statistics estimated in S403 and the captured image input in S405 in comparison processing in S406. The model data in S401 enables estimation of the corresponding captured image from the design pattern data image and the process information through the learning processing. Here, specific examples of the loss function include a mean square error, a cross entropy error, and the like.

The reference data input in S402 is the design pattern data image in the present embodiment.

Examples of the learning necessity determination in S404 include determination of whether or not the number of times the learning is repeated is equal to or greater than a specified number of times, whether or not the loss function used for learning has converged, and the like.

The model data stored in S408 is stored by outputting the weight of each layer of the CNN as a file in a predetermined format.

Next, the relationship between the design pattern data image and the captured image of the circuit used in the learning processing will be described.

In S406, the estimated captured image statistics (estimated captured image) is compared with the captured image. At this time, in order to correctly compare the design pattern data with the captured image, the design pattern data and the captured image need to be aligned. Therefore, a dataset for training (training dataset) requires a pair of the aligned design pattern data image and captured image. In general, it is preferable that the number of images in the training dataset is large. In addition, it is preferable that the pattern of the circuit used for learning is similar to the pattern of the circuit used for evaluation.

In order to learn the deformation of the circuit from the design pattern data, the design pattern data accepted in S401 and the captured image accepted in S405 need to be aligned. The design pattern data image for learning and the captured image of the circuit manufactured based on the design pattern data image are aligned on the image in such a way that the circuit patterns match. Examples of the alignment method include a method of obtaining contour lines of the wirings of the design pattern data image and the captured image, and performing positioning in such a way that centroids of figures surrounded by the contour lines match each other.

As the process information used in the learning processing or the process information used in the processing of estimating the captured image statistics using the trained model data, only a parameter to be considered may be used, or all the parameters related to the manufacturing process or the image capturing process may be used. However, in a case where the process information increases, the arithmetic operation amount in the CNN increases, and thus, it is preferable to use only the minimum necessary parameters from the viewpoint of the processing speed.

As an example of the comparison processing in S406, calculation of a difference between an image sampled based on the statistics and the captured image is performed.

In summary, the machine learning unit determines the necessity of learning for the model data, and in a case where it is determined in the learning necessity determination step that the learning is necessary, the machine learning unit accepts input of the training dataset including the reference data, the process information, and the captured image for learning, compares the captured image statistics with the captured image data of the training dataset, and updates the model data based on the comparison result. On the other hand, in a case where it is determined in the learning necessity determination step that the learning is unnecessary, the storage unit stores, as the model data, a parameter used when the estimation unit calculates the captured image statistics.

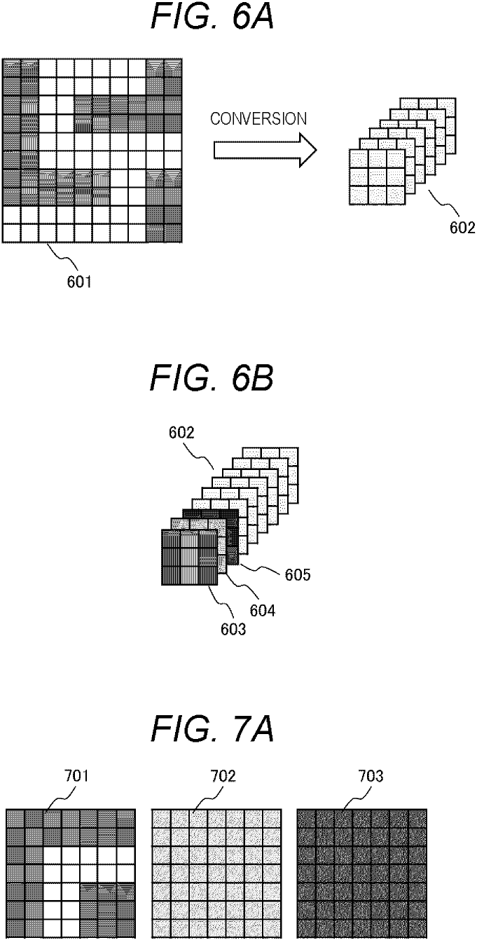

Next, an example of an input form of the design pattern data image and the process information input in S402 will be described with reference to FIGS. 6A and 6B and FIGS. 7A and 7B.

FIG. 6A schematically illustrates an example of converting a design pattern data image into a feature.

FIG. 6A is a diagram illustrating an example of a design pattern data image 601 and a feature 602 calculated by two or more convolutional layers included in a neural network model.

The design pattern data image 601 is a binary image obtained by imaging design pattern data such as CAD. Here, squares in a grid represent respective pixels constituting the image.

The feature 602 is calculated from the design pattern data image 601 by using a convolutional layer (encoder layer) of a CNN included in a captured image statistics estimation unit (estimation unit), and is represented by a matrix. The feature 602 includes design pattern information indicating to which of a wiring portion and the other portion each pixel on the design pattern data image belongs, design pattern information regarding a pattern and arrangement of the wiring in the vicinity of an edge or a corner of the wiring, and the like. The feature 602 can be expressed as a three-dimensional matrix having a height, a width, and a channel. In this case, the height, width, and channel of the feature 602 calculated from the design pattern data image 601 are determined depending on the number of convolutional layers of the CNN, the filter size, the stride size, the padding size, or the like.

FIG. 6B illustrates an example of a combination form of the feature and the process information.

As illustrated in FIG. 6B, the feature 602 in FIG. 6A is expressed as a three-dimensional matrix combined with pieces of process information 603, 604, and 605.

As the pieces of process information 603, 604, and 605, a real number indicating the manufacturing condition or the image capturing condition is expressed as a matrix of which a height and a width are equal to those of the feature 602 and a channel size is 1, and the pieces of process information 603, 604, and 605 are expressed as three-dimensional matrices. Specifically, a three-dimensional matrix of which values of all elements are 1, a height and a width are equal to those of the feature 602, and a channel size is 1 is prepared, and the three-dimensional matrix is multiplied by a real number indicating the manufacturing condition or the image capturing condition.

In a case of inputting to the CNN included in the captured image statistics estimation unit, the design pattern data image 601 is converted into the feature 602 by the convolutional layer (encoder layer) of the CNN, the feature 602 and the process information 603, 604, and 605 are combined in the order of channels, and the combination result is input to a deconvolutional layer (decoder layer) included in the CNN. Here, a case where there are three pieces of process information has been described, but the number of pieces of process information to be used may be one or two or more, and is not limited.

FIG. 7A is a diagram illustrating an example of the input form according to the present embodiment.

FIG. 7A schematically illustrates a design pattern data image 701, process information 702, and process information 703 as examples.

The design pattern data image 701 is an image of design pattern data such as CAD. Examples thereof include a binary image in which a wiring portion and a space portion of the circuit are painted differently. In a case of the semiconductor circuit, there is a multilayer semiconductor circuit having two or more layers of wiring. For example, in a case where the number of layers of wiring is one, a binary image with a wiring portion and a space portion can be used, and in a case where the number of layers of wiring is two, a ternary image with lower and upper wiring portions and a space portion can be used. The design pattern data image is an example of the reference image, and the reference image is not limited thereto.

The process information 702 and the process information 703 each provide a real number indicating the manufacturing condition or the image capturing condition as an image having the same size as that of the design pattern data image. Specifically, a matrix of which values of all elements are 1 and an image size is the same as that of the design pattern data is multiplied by a real number indicating the manufacturing condition or the image capturing condition.

FIG. 7B is a diagram illustrating an example of the combination form according to the present embodiment.

FIG. 7B schematically illustrates a design pattern data image 701, process information 702, and process information 703 as examples.

An example of a method of inputting to the CNN included in the captured image statistics estimation unit is to combine the design pattern data image 701, the process information 702, and the process information 703 in the order of channels of the image. Here, a case where there are two pieces of process information has been described, but the number of pieces of process information to be used may be one or two or more, and is not limited.

Note that the method for combining the process information illustrated in FIGS. 6A to 7B is not limited thereto.

In addition, it is possible to evaluate an influence of the process information on the circuit or the captured image of the circuit.

For example, the captured image statistics are calculated by changing only one of the parameters included in the process information. At this time, it is possible to observe a manner of deformation that appears when actually manufactured and captured from the mean image and to observe how much deformation range is assumed in each portion of the circuit from the standard deviation image. Therefore, if there is model data created by training in advance, it is possible to evaluate an influence on the deformation of the circuit or the image quality of the captured image without actually performing manufacturing and image capturing. In a case where the change in process information causes a small change in the mean image and a small value of the standard deviation in the standard deviation image, it can be said that the influence of the parameters on the pattern deformation of the circuit and the degree of variation thereof is small.

A case where the number of pieces of process information is two and only one of the pieces of process information is changed is described in the present embodiment, but the present invention is not limited thereto, and the number of parameters included in the process information may be one or three or more. In addition, only one parameter in the process information may be changed and executed, or a plurality of parameters may be changed and executed.

Next, as another embodiment of the estimation unit 202 of FIG. 2, a case of creating a template image for pattern matching will be described.

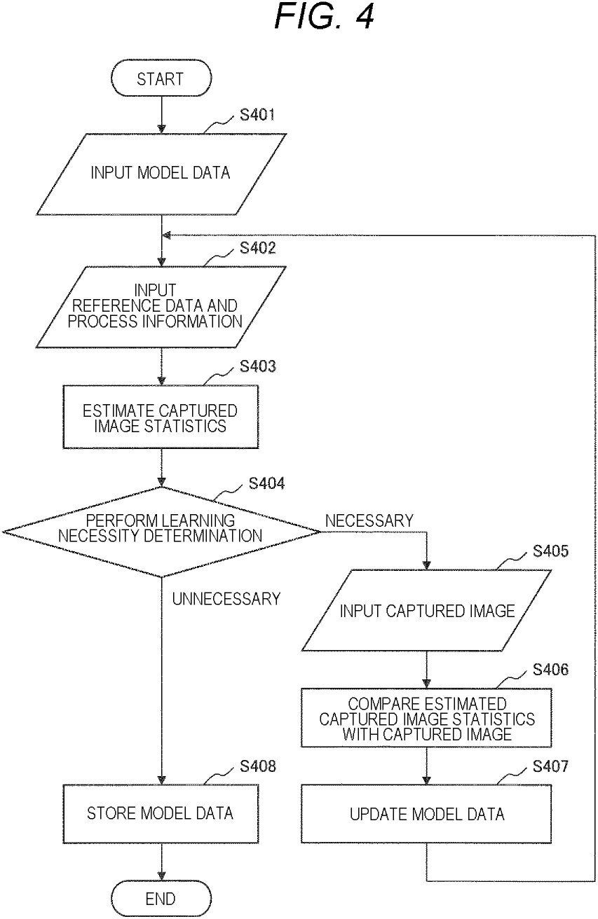

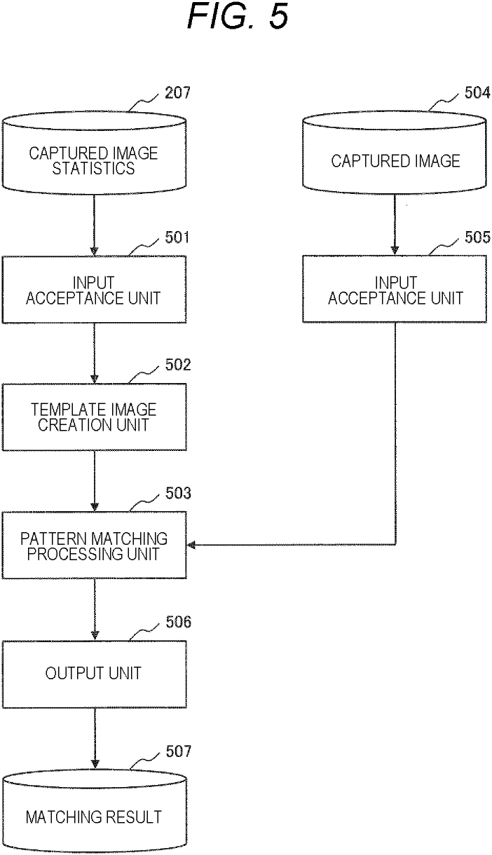

FIG. 5 is a configuration diagram illustrating a flow of data processed in the pattern inspection system, and illustrates an example of processing of performing the pattern matching using the captured image statistics.

The pattern inspection system illustrated in FIG. 5 includes an input acceptance unit 501 to which the captured image statistics 207 are input, an input acceptance unit 505 to which a captured image 504 is input, a template image creation unit 502, a pattern matching processing unit 503, and an output unit 506. Note that the flow of data illustrated in FIG. 5 is an example of the pattern inspection method.

The captured image 504 is a captured image (actual captured image) targeted for the pattern matching.

The captured image statistics 207 are calculated by the estimation unit 202 when the input acceptance unit 201 illustrated in FIG. 2 accepts process information when manufacturing a circuit of the captured image 504 and capturing an image of the circuit, a design pattern data image of the circuit of the captured image 504, and model data created by the learning processing, and are output by the output unit 203.

The pattern matching processing illustrated in FIG. 5 is performed as follows.

The input acceptance unit 501 accepts the captured image statistics 207, and the template image creation unit 502 converts the captured image statistics 207 into a template image and transfers the template image to the pattern matching processing unit 503. Meanwhile, the input acceptance unit 505 accepts the captured image 504 and transfers the captured image 504 to the pattern matching processing unit 503.

The pattern matching processing unit 503 performs the pattern matching processing by using the captured image 504 and the template image. Then, the output unit 506 outputs a matching result 507.

The pattern matching processing unit 503 performs processing of comparing the template image with the captured image 504 and aligning the template image and the captured image.

A specific example of the method is to calculate normalized cross-correlation as a similarity score while shifting the relative positions of the template image and the captured image 504, and to output a relative position having the highest similarity score. The format of the matching result 507 may be, for example, a two-dimensional coordinate value representing a movement amount of the image, or may be an image in which the template image and the captured image 504 are overlaid at a position having the highest similarity.

The input captured image statistics 207 are estimated by the estimation unit 202 in FIG. 2 by using the design pattern data image and the process information corresponding to the captured image 504 to be matched. At this time, the model data provided to the estimation unit 202 is desirably created by the learning processing in advance of the pattern matching processing.

Examples of the template image created by the template image creation unit 502 include a mean image obtained by imaging a mean value of the captured image statistics 207, and a sampling image obtained by sampling a value of each pixel from the captured image statistics 207.

As the captured image of the circuit used in the learning processing performed before the pattern matching processing, a captured image acquired from a wafer manufactured in the past may be used, or a captured image acquired from a matching target wafer may be used.

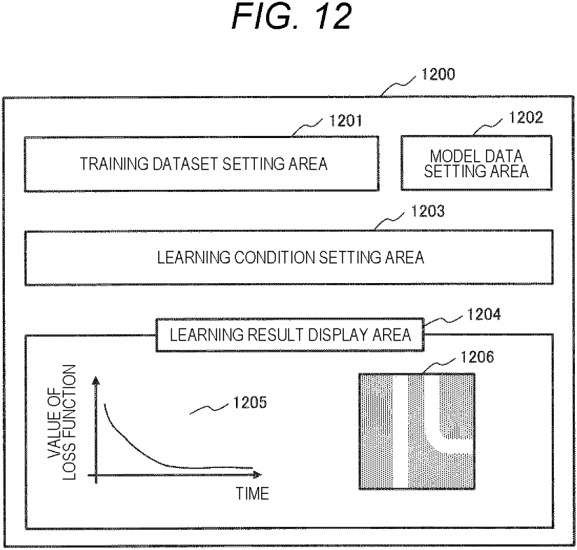

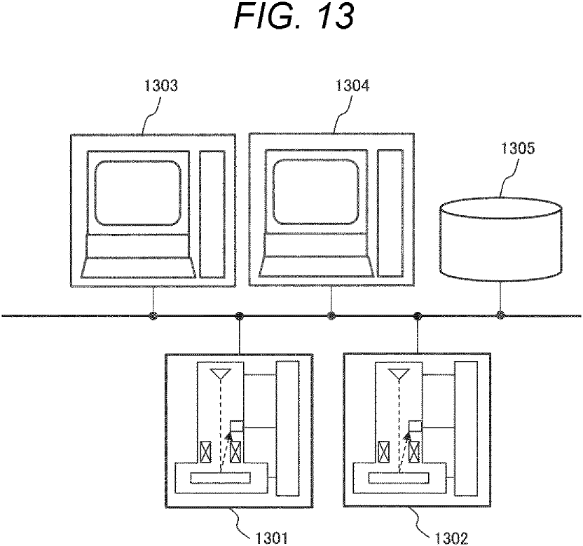

FIG. 11 is a configuration diagram illustrating a GUI for estimating captured image statistics and evaluating a circuit. Here, the GUI is an abbreviation of a graphical user interface.

The GUI (1100) illustrated in FIG. 11 displays a design pattern data image setting area 1101, a model data setting area 1102, a process information setting area 1103, an evaluation result display area 1104, and a display image manipulation area 1107.

The design pattern data image setting area 1101 is an area for performing setting regarding a design pattern data image necessary for estimating the captured image statistics.

The model data setting area 1102 is an area for performing setting regarding trained model data necessary for estimating the captured image statistics.

The process information setting area 1103 is an area for performing setting regarding process information necessary for estimating the captured image statistics. Examples of a method of setting the process information include a method of individually inputting a parameter necessary for each process such as lithography and etching.

In the design pattern data image setting area 1101, the model data setting area 1102, and the process information setting area 1103, respective data are read by designating a storage area stored in a predetermined format.

The evaluation result display area 1104 is an area for displaying information regarding the captured image statistics estimated from the data set in the design pattern data image setting area 1101, the model data setting area 1102, and the process information setting area 1103. Examples of the displayed information include a mean image 1105 and a standard deviation image 1106 created from the captured image statistics.

The display image manipulation area 1107 is an area for performing a manipulation related to the information displayed in the evaluation result display area 1104. Examples of the manipulation include switching a displayed image to another image and enlarging or reducing an image.

FIG. 12 is a configuration diagram illustrating a GUI for performing the learning processing.

The GUI (1200) illustrated in FIG. 12 displays a training dataset setting area 1201, a model data setting area 1202, a learning condition setting area 1203, and a learning result display area 1204.

The training dataset setting area 1201 is an area for performing setting regarding a training dataset including a design pattern data image, process information, and a captured image to be used in the learning processing. Here, data is read by designating a storage area stored in a predetermined format.

The model data setting area 1202 is an area for performing setting regarding model data that is input, updated, and stored in the learning processing. Here, the learning condition setting area 1203 in which model data is read by designating a storage area stored in a predetermined format is an area for performing setting regarding the learning condition of the learning processing. For example, the number of times learning is performed may be designated for the learning necessity determination S404, or a value of the loss function serving as a reference for terminating learning may be designated.

The learning result display area 1204 is an area for displaying a progress of the learning processing or a learning result after the termination of the learning processing. A graph 1205 of a temporal change of the loss function may be displayed, or an image 1206 obtained by visualizing the captured image statistics estimated using the model during the learning or after the termination may be displayed.

The GUI (1100) and the GUI (1200) may be individual interfaces or may be integrated as a GUI related to the learning processing and the evaluation. Furthermore, the areas for setting, display, or manipulation displayed in the GUI (1100) or the GUI (1200) are an example, and not all the areas are essential for the GUI and only some of the areas may be implemented. In a case of a device that performs these pieces of processing, similarly to the program, one device may perform the pieces of processing or different devices may perform the pieces of processing.

The processing of estimating the captured image statistics in FIGS. 2, 3A, and 3B, the learning processing in FIG. 4, and the pattern matching processing in FIG. 5 may be performed by different programs, respectively, or may be performed by individual programs, respectively. In a case of a device that performs these pieces of processing, similarly to the program, one device may perform the pieces of processing or different devices may perform the pieces of processing.

Note that the present invention is not limited to the embodiments described above, but includes various modified examples. For example, the above-described embodiments have been described in detail in order to explain the present invention in an easy-to-understand manner, and the present invention is not necessarily limited to those having all the configurations described.

According to the present embodiment, it is possible to estimate, as the statistics, a deformation range of a pattern of a sample according to process information from a design pattern data image based on a correspondence relationship among a reference image such as design pattern data of the sample, the process information, and a captured image. Therefore, it is possible to perform pattern matching with respect to the captured image of the sample by using the estimated statistics.

Note that the present embodiment can be applied to other than the semiconductor circuit as an evaluation target. In addition, input data (pattern measurement by a radar) other than images can be used.

Hereinafter, effects of the present invention will be collectively described.

According to the present invention, it is possible to estimate deformation or physical properties of an arbitrary sample and variation in image quality of a captured image of the sample from reference data of the sample and process information, which is a parameter set in a manufacturing process or an image capturing process for the sample, based on a correspondence relationship among the reference data such as design pattern data of the sample, the process information, and the captured image of the sample.

For example, a deformation range of a circuit under the conditions can be directly estimated from an arbitrary design pattern data image and arbitrary process information by using a mathematical model configured by learning a correspondence relationship between design pattern data of the circuit acquired before evaluation such as measurement or inspection, a part or all of the process information used in a manufacturing process or an image capturing process for the circuit, and a captured image. Therefore, if a template image for pattern matching is created from the estimation result and used, it is possible to implement highly accurate pattern matching in consideration of a difference in deformation range caused by a difference in process information.

In addition, since the correspondence relationship is learned using the design pattern data, the process information, and the captured image, a dependence relationship of parameters between a plurality of manufacturing processes or image capturing processes (lithography process, etching process, image capturing process, and the like) can be estimated as a pattern change of the circuit appearing in the captured image or an image quality change of the captured image by complexly adding the parameters of the plurality of manufacturing processes or image capturing processes to the process information. In a combination of conventional process simulations, the processing time is long, and thus the present invention is superior in terms of speed.

Furthermore, according to the present invention, it is possible to provide a computer program for predicting deformation of a circuit caused according to process information or a change in image quality of a captured image of the circuit, and a semiconductor inspection device using the computer program.

Reference Signs List
101 design pattern data image
102, 103 process information
104, 105, 504 captured image
202 estimation unit
204 reference data
205 process information
206, 301 model data
207 captured image statistics
303 mean image
304 standard deviation image
502 template image creation unit
503 pattern matching processing unit
901 probability density function
1100, 1200 GUI

1. An image processing method for acquiring data of an estimated captured image obtained from reference data of a sample by using a system including an input acceptance unit, an estimation unit, and an output unit, the data being used when comparing the estimated captured image and an actual captured image of the sample, the image processing method comprising:
an input step of accepting, by the input acceptance unit, input of the reference data, process information of the sample, and trained model data;
an estimation step of calculating, by the estimation unit, captured image statistics which represent a probabilistic distribution of values that are attainable by data of the captured image by using the reference data, the process information, and the model data; and
an output step of outputting, by the output unit, the captured image statistics,
wherein the estimated captured image is able to be generated from the captured image statistics.

2. The image processing method according to claim 1, wherein the system further includes a machine learning unit and a storage unit,
the image processing method further comprises a learning necessity determination step of determining, by the machine learning unit, necessity of learning for the model data,
in a case where it is determined in the learning necessity determination step that the learning is necessary, input of a training dataset including the reference data, the process information, and the captured image for the learning is accepted, the captured image statistics and the data of the captured image of the training dataset are compared with each other, and the model data is updated based on a result of the comparison, and
in a case where it is determined in the learning necessity determination step that the learning is unnecessary, the storage unit stores, as the model data, a parameter used when the estimation unit calculates the captured image statistics.

3. The image processing method according to claim 1, wherein the process information includes a manufacturing condition for the sample or an image capturing condition for the captured image.

4. The image processing method according to claim 1, further comprising a step of evaluating an influence of the process information on the sample by using the captured image statistics.

5. The image processing method according to claim 1, wherein the captured image statistics include a mean image and a standard deviation image.

6. The image processing method according to claim 1, wherein the sample is a semiconductor circuit.

7. A pattern inspection method for inspecting a pattern of the sample by using the captured image statistics obtained by the image processing method according to claim 1, the system further including a template image creation unit and a pattern matching processing unit, and the pattern inspection method comprising:
accepting, by the input acceptance unit, input of the data of the captured image;
creating, by the template image creation unit, a template image from the captured image statistics;
performing, by the pattern matching processing unit, pattern matching between the template image and the captured image; and
outputting, by the output unit, a result of the pattern matching.

8. A pattern inspection method for inspecting a pattern of the sample by using the captured image statistics obtained by the image processing method according to claim 2, the system further including a template image creation unit and a pattern matching processing unit, and the pattern inspection method comprising:
accepting, by the input acceptance unit, input of the data of the captured image;
creating, by the template image creation unit, a template image from the captured image statistics;
performing, by the pattern matching processing unit, pattern matching between the template image and the captured image; and
outputting, by the output unit, a result of the pattern matching.

9. An image processing system that acquires data of an estimated captured image obtained from reference data of a sample when comparing the estimated captured image and an actual captured image of the sample, the image processing system comprising:
an input acceptance unit that accepts input of the reference data, process information of the sample, and trained model data;
an estimation unit that calculates captured image statistics which represent a probabilistic distribution of values that are attainable by data of the captured image by using the reference data, the process information, and the model data; and
an output unit that outputs the captured image statistics,
wherein the estimated captured image is able to be generated from the captured image statistics.

10. The image processing system according to claim 9, further comprising:
a machine learning unit; and
a storage unit,
wherein the machine learning unit determines necessity of learning for the model data,
in a case where it is determined by the machine learning unit that the learning is necessary, input of a training dataset including the reference data, the process information, and the captured image for the learning is accepted, the captured image statistics and the data of the captured image of the training dataset are compared with each other, and the model data is updated based on a result of the comparison, and
in a case where it is determined by the machine learning unit that the learning is unnecessary, the storage unit stores, as the model data, a parameter used when the estimation unit calculates the captured image statistics.

11. The image processing system according to claim 9, wherein the process information includes a manufacturing condition for the sample or an image capturing condition for the captured image.

12. The image processing system according to claim 9, wherein an influence of the process information on the sample is evaluated by using the captured image statistics.

13. The image processing system according to claim 9, wherein the captured image statistics include a mean image and a standard deviation image.

14. The image processing system according to claim 9, wherein the sample is a semiconductor circuit.

15. A pattern inspection system that inspects a pattern of the sample by using the captured image statistics, the pattern inspection system comprising:
the image processing system according to claim 9,
wherein the pattern inspection system further includes a template image creation unit and a pattern matching processing unit,
the input acceptance unit accepts input of the data of the captured image,
the template image creation unit creates a template image from the captured image statistics,
the pattern matching processing unit performs pattern matching between the template image and the captured image, and
the output unit outputs a result of the pattern matching.

16. A pattern inspection system that inspects a pattern of the sample by using the captured image statistics, the pattern inspection system comprising:
the image processing system according to claim 10,
wherein the pattern inspection system further includes a template image creation unit and a pattern matching processing unit,
the input acceptance unit accepts input of the data of the captured image,
the template image creation unit creates a template image from the captured image statistics,
the pattern matching processing unit performs pattern matching between the template image and the captured image, and
the output unit outputs a result of the pattern matching.
